(19) United States
(12) Patent Application Publication
(10) Pub. No.: US 2006/0065417 A1
(43) Pub. Date: Mar. 30, 2006

(54) Drilling and/or chusel hammer

(75) Inventors: Josef Funfer, Koenigsbrunn (DE); Dirk Schinkitz, Frastanz (AT)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/232,385

(22) Filed: Sep. 20, 2005

(30) Foreign Application Priority Data
Sep. 30, 2004 (DE) 10 2004 047 606.3

(51) Int. Cl. B25D 11/00

(52) U.S. Cl. 173/201; 173/109

(57) ABSTRACT

A percussion hammer, in particular a drilling and/or chisel hammer includes a first housing part (11) in which the hammer motor (3) is arranged, a second housing part (12) in which the drive gear (4) is arranged, and a third housing part (21) in which the percussion mechanism (5) is arranged, with at least one of the first, second and third housing parts (11, 12, 21) being formed of a drawn profile.

### BACKGROUND OF THE INVENTION

1. Field of the Invention

The present invention relates to a percussion hammer and, in particular, a drilling or chisel hammer including a percussion mechanism, a motor for driving the percussion mechanism, a drive gear connecting the percussion mechanism with the motor, a first housing part in which the motor is arranged, a second housing part in which the drive gear is arranged, and a third housing part in which the percussion mechanism is arranged.

2. Description of the Prior Art

In conventional drilling and/or chisel hammer, the motor and the drive gear are arranged in respective housing parts, which are located within the hammer housing, for protection from outside influences. For guiding at least one of the components of the percussion mechanism, there is provided a further housing part that is usually formed of two parts, an inner guide tube and a surrounding it, flange tube. Because of formation of the further housing part of two parts, assembly costs are increased and the weight is likewise increased.

German Publication DE 42 41 000 A1 discloses a drilling and/or percussion hammer in which the percussion mechanism is received and guided in a separate hammer tube. The hammer tube is formed of a smooth tubular section that is formed to a desired shape with a forging hammer and a kneader. The drawbacks of this type of formation of the hammer tube consist in that the formation of the hammer tube, which is a precision steel tube, is very expensive, and the tube has a large weight.

U.S. Pat. No. 5,445,232 discloses a hydraulic breaking hammer for hydraulically driven digging machines and bucket excavators and having a one-piece hammer housing formed of cast metal. The hammer housing includes a housing part or a guide tube for the percussion mechanism, a housing support, and reinforced intermediate walls. The drawback of the cast hammer housing consists in that the housing has a very large weight and is, therefore, not suitable for hand-held drilling and/or chisel hammer.

Accordingly, an object of the present invention is to provide housing parts for separate components, in particular, of a hand-held drilling and/or chisel hammer and which can be conveniently and flexibly produced.

Another object of the present invention is to provide housing parts for separate hammer components that would have a reduced weight.

### SUMMARY OF THE INVENTION

These and other objects of the present invention, which will become apparent hereinafter, are achieved by forming at least one of the housing parts of a drawn profile.

Dependent on the function of the housing part, e.g., for protection of the motor or the drive gear, or for guiding separate components of the percussion mechanism, and dependent on dimensions of separate parts of the drilling and/or chisel hammer, a cross-section of the to-be-drawn profile is determined, and a section of the profile having a predetermined length is produced as a semifinished product. Different housing part concepts can be realized through drawn profile sections having different lengths. Forming housing parts of drawn profiles substantially reduces manufacturing costs of the tools in comparison with the known solution. In addition, the drawn profile sections of predetermined lengths have, at a constant wall thickness, an uninterrupted fiber orientation, which insures a long usable life of the sections and their reliability. Moreover, housing parts which are formed of drawn profiles, are recycling-friendly, as there is no need in separation of materials during disposal of the housing parts.

Advantageously, the drawn profile is produced of an aluminum alloy. Housing parts, which are produced from drawn profiles formed of an aluminum alloy, have a small weight. A drawn profile can, e.g., be produced of an aluminum alloy according to DIN EN 1706 or DIN EN 55, part 1-9.

Alternatively, the drawn profile can be produced of magnesium alloy. Housing parts, which are produced from drawn profiles formed of magnesium alloy, have, in comparison with their dimensions, also a low weight. The drawn profiles for housing parts can be produced, e.g., from a magnesium alloy according to ASTM B107/B107M or DIN 977-1, -2, -3.

When several housing parts, which are arranged within the hammer housing of the drilling and/or chisel tool, are produced from a drawn profile, advantageously, all of the housing parts for components of the hammer are formed of drawn profiles which are formed of the same materials. Thereby, all of the housing parts are connectable due to adhesion of the material. In a chisel hammer, all of the housing parts can form a housing group, which enables an easy assembly and insure a small weight. In a drilling hammer, the third housing part is rotatably arranged with respect to the first and/or second housing part.

Advantageously, the first housing part and the second housing part are formed as a single integral housing part or as a housing unit. The housing unit or block is formed of a single drawn profile having a correspondingly formed cross-section.

With formation of the first and second housing parts as a single unit, separate wall sections can be dispensed with, which further reduces the weight of the housing parts for hammer components. With the use of a single drawn profile, an adequate strength of the housing unit or the housing block is insured.

Advantageously, at least one cover section is provided on the first housing part for the motor and/or the second housing part for the drive gear, which insures protection of the motor which is located within the first housing part, and for the drive gear which is located within the second housing part, from outside influences in a simple way. Advantageously, cover sections are provided at both ends of the respective housing part or parts. For cooling of the motor and/or the drive gear, in at least one of the cover sections, there are provided openings for delivery and removal of the cooling air. The provision of the cooling openings in the cover sections eliminates a need in further treatment of the drawn profile, which permits to keep the manufacturing costs low. On the drawn profile, there are provided receptacles for fastening means, e.g., screws which insures an easy mounting or attachment of the cover section. The cover section(s) is (are) formed, e.g., of light metal or a suitable plastic material.

Advantageously, the third housing part is formed as a guide tube, with at least one of the anvil and the driving piston of the percussion mechanism being displaceably arranged in the guide tube. According to the invention; drawn profiles having different length are provided for different types of the percussion mechanism. With forming housing parts of drawn profiles, less separate parts for the housing are needed, which not only favorably influences the total weight of the power tool but also reduces the assembly costs.

Advantageously, the guide tube has a plurality of channels extending in the longitudinal direction of the guide tube, which permits to eliminate a sheathing tube such as a flange tube. Through the channels, the cooling air or the outgoing air from the motor and/or the drive gear for removal heat, which is generated during the operation of the drilling and/or chisel hammer, flows. This insures an easy and simple cooling of the running surfaces in the guide tube.

Advantageously, the guide tube has outwardly extending ribs which provide for additional cooling of the drilling and/or chisel hammer that is cooled by the cooling air or by drawing air off the drilling and/or chisel hammer. Both measures separately and, in particular, together insure that the guide tube for the percussion mechanism, which is made of a drawn profile, generates only very little heat draft and, therefore, has a sufficiently long service life.

Advantageously, the running surfaces of the guide tube are coated to provide self-lubricating running surfaces for components of the percussion mechanism arranged in the guide tube. The running surfaces are coated using a chemical vapor deposition process or a plasma vapor deposition process. A further possibility consists in using an oxidation process for coating the running surfaces, e.g., coating of the running surfaces of a guide tube, which is formed of an aluminum alloy can be effected using hard anodic oxidation. In addition to the above-mentioned, but not exclusive, types of coating processes, for improvement of sliding characteristics of the running surfaces of the guide tube, sleeves can be used.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side, partially cross-sectional view of a chisel hammer according to the present invention; and

FIG. 2 a cross-sectional view along line II-II in FIG. 1.

### DETAILED DESCRIPTION OF THE INVENTION

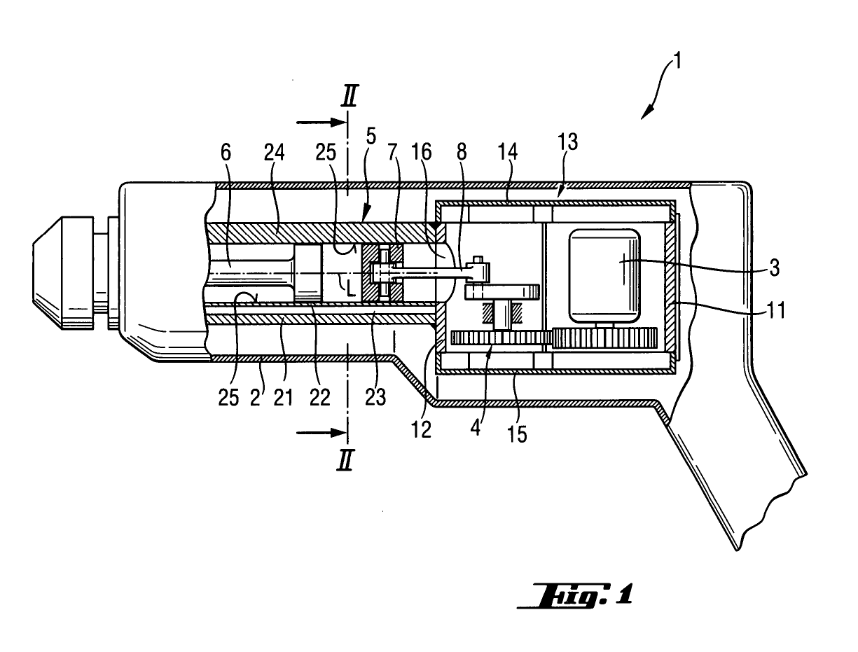

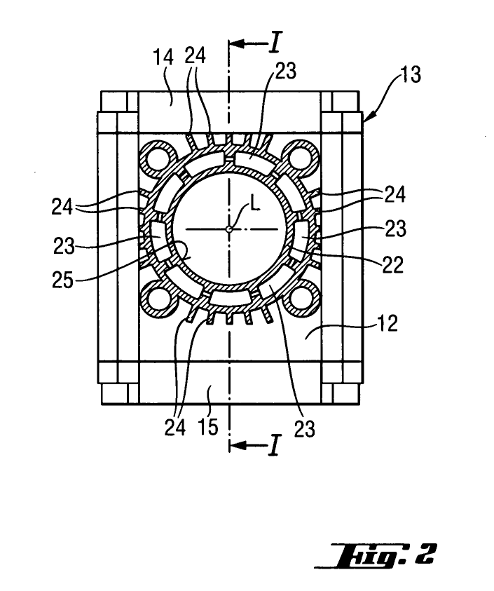

A chisel hammer 1 according to the present invention, which is shown in FIGS. 1-2, includes a housing 2, a motor 3 arranged in a first housing part 11, a drive gear 4 arranged in a second housing part 12, and a percussion mechanism 5 arranged in a third housing part 21. All of the three housing parts 11, 12, and 21 are formed of drawn profiles which are produced from aluminum alloys.

The first and second housing parts 11 and 12 are formed as an integral housing part 13 of a single drawn profile section. For closing the end sides of the drawn profile section, there are provided two cover sections 14, 15 on the first housing part 11 and on the second housing part 12 or on the integral housing part 13.

The third housing part 21 is formed as a guide tube 22 in which there are arranged an anvil 6 and a driving piston 7 of the percussion mechanism 5. The guide tube 22 has a plurality of channels 23 extending in a longitudinal direction L, and a plurality of extending outwardly ribs 24. In order to improve its sliding characteristics and strength, running surfaces 25 of the guide tube 22 are coated in a vacuum deposition process.

The third housing part 21, in which the percussion mechanism 5 is arranged, is fixedly connected with the second housing part 12, in which drive gear 4 is arranged, or with the integral housing part 13 by an inert gas shielded arc welding process. Before the third housing part 21 is welded to the second housing part 12, there is formed in the housing part 12 or in the integral housing part 13, an opening 16 that opens the housing part 12 or the integral housing part 13 toward the third housing part 21 and provides for connection of the driving piston 7, which is located in the guide tube 22, with the drive gear 4. The driving piston 7 is connected with the drive gear 4 by a connecting rod 8. The housing parts 11, 12, and 21 form a housing assembly that has a small weight and enables an easy assembly of the chisel hammer 1.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A percussion hammer, comprising a percussion mechanism (5); a motor (3) for driving the percussion mechanism (5); a drive gear (4) connecting the percussion mechanism (5) with the motor (3); a first housing part (11) in which the motor (3) is arranged; a second housing part (12) in which the drive gear (4) is arranged; and a third housing part (21) in which the percussion mechanism (5) is arranged,
wherein at least one of the first, second, and third housing parts (11, 12, 21) is formed of a drawn profile.

2. A percussion hammer according to claim 1, wherein the drawn profile the at least one of the first, second and third housing parts (11, 12, 21) is formed of, is produce from aluminum alloy.

3. A percussion hammer according to claim 1, wherein the drawn profile the at least one of the first, second and third housing parts (11, 12, 21) is formed of, is produced from a magnesium alloy.

4. A percussion hammer according to claim 1, wherein the first housing part (11) and the second housing part (12) are formed as an integral housing part (13).

5. A percussion hammer according to claim 1, wherein at least one cover section (14, 15) is provided on at least one of the first housing part (11) and the second housing part (12).

6. A percussion hammer according to claim 1, wherein the third housing part (21) is formed as a guide tube (22), and wherein the percussion mechanism (5) comprises an anvil (6) and a driving piston (7), with at least one of the anvil (6) and the driving piston (7) being displaceably arranged in the guide tube (22).

7. A percussion hammer according to claim 6, wherein the guide tube (22) has a plurality of channels (23) extending in a longitudinal direction (L) of the guide tube (22).

8. A percussion hammer according to claim 6, wherein the guide tube (22) has a plurality of extending outwardly ribs (24).

9. A percussion hammer according to claim 6, wherein the guide tube (22) has coated running surfaces (25).
